(19) United States
(12) Patent Application Publication
(10) Pub. No.: US 2008/0016307 A1
(43) Pub. Date: Jan. 17, 2008

(54) STORAGE DEVICE AND STORING METHOD

(76) Inventors: HARUKO TAKANO, Yokohama (JP); YUKIHIDE INAGAKI, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/769,835

(22) Filed: Jun. 28, 2007

(30) Foreign Application Priority Data
Jun. 28, 2006 (JP) 2006-178412

(51) Int. Cl. G06F 12/00; G06F 12/16

(52) U.S. Cl. 711/164; 711/162; 711/E12.001

(57) ABSTRACT

In order to securely back up data that is recorded in a mobile storage device, a storage device that connects to an external device so as to communicate with the external device includes a switch for switching functions of a control section under the control, a section for holding unique information belong to the storage device, a section for receiving a unique key belonging to the external device from the external device, a section for generating a backup key by use of the unique key belonging to the external device which has been obtained from the external device and the unique information belonging to the storage device, a section for encrypting a copy of digital data that has been recorded in the storage device by use of the backup key.

### CLAIM OF PRIORITY

The present application claims priority from Japanese application JP 2006-178412 filed on Jun. 28, 2006, the content of which is hereby incorporated by reference into this application.

### FIELD OF THE INVENTION

The present invention relates to a storage device and a storing method, and more particularly to a storage system and method for securely backing up or restoring data that has been recorded in a storage device such as a hard disc drive, and a terminal device that is used in the storage system or method.

### BACKGROUND OF THE INVENTION

With the diffusion of an Internet, it is possible to watch a streaming broadcast or watch the downloaded contents. The digitalization of the contents has the user's merit as such, but suffers from such a problem that falsification or copy can be relatively easily performed. Moreover, since the image quality is not deteriorated, there is a fear that illegal copy is frequently performed, and copyright is infringed. In order to solve the above problem, there have been proposed diverse DRM (digital rights management) techniques. As an example of the DRM, there is a copy limit of the contents.

As a storage medium of the digital contents, there are storage media such as an HDD (hard disc drive), a memory card, or an optical disc. Those storage media allow data to be destroyed or erased due to an impact or temperature. Also, there is the possibility that the storage medium per se is destroyed and data is not read from the storage medium. It is convenient to back up the data just in case the data is lost.

On the other hand, to back up the data to another storage medium is nothing other than copying the contents. When backup and restoration are allowed, there is the possibility that the contents with copyright are illegally used by a malicious user. For that reason, a demand has been made for a copyright protection technique that enables backup and restoration only in the case where data is lost unintentionally, for example, because of the crush of HDD.

For example, JP-A 2003-337754 discloses a method of backing up or restoring the contents that have been recorded in a system HDD incorporated into a storage device. That is, when the contents are backed up, three kinds of data are recorded into a backup HDD. Those three kinds of data is made up of data resulting from encrypting contents Tk with a contents key Kck, data resulting from encrypting the contents key Kck with a contents original key Kcr, and data resulting from encrypting the contents original key Kcr with a backup key KB. When the backup data is restored, the storage device transmits the backup key KB to a server on a network, and the server compares the backup key KB that has been registered in advance with the received backup key KB to specify the storage device. Then, the server e-signs a verification flag that allows the restoration and the backup key KB, and then transmits those electronic signatures to the storage device. The storage device decrypts the received electronic signatures, and acquires the backup key KB and the verification flag. The storage device compares the received backup key KB with the backup key KB held by the storage device. Thereafter, the storage device compounds the contents original key Kcr that has been recorded in the backup HDD by use of the backup key KB that has been acquired from the server, and compares the compound contents original key Kcr with the contents original key within the storage device to verify the consistency with the backup HDD. After the storage device takes the consistency of the backup HDD with the storage device, the storage device restores the backup data within the backup HDD in a system HDD within the storage device.

### SUMMARY OF THE INVENTION

In the conventional art disclosed in JP-A 2003-337754, it is necessary to connect the storage device to an external device such as the server at the time of restoration, and to verify the consistency that the storage device that is to restore the data is identical with the storage device that has backed up the data. However, the above method cannot be adaptive to a case where there are no network environments, or a case where a terminal device has no network connecting function because data is not restored unless the storage device is connected to the Internet.

An object of the present invention is to securely backs up data that has been recorded in the mobile storage device.

According to the present invention, there is provided a storage device, preferably, a storage device that connects to an external device so as to communicate with the external device, which has a storage area that records data therein, and a control section that controls the record of data in the storage area, the storage device including: switching means for switching functions of the control section under the control; means for holding unique information belong to the storage device; means for receiving a unique key belonging to the external device from the external device; means for generating a backup key by use of the unique key belonging to the external device which has been acquired from the external device and the unique information belonging to the storage device; and means for encrypting a copy of digital data that has been recorded in the storage device by use of the backup key.

According to the present invention, there is provided a storing method, preferably, a method of backing up data that has been recorded in a storage device, the method including: holding unique information belonging to the storage device in advance; receiving a unique key held by a terminal device that is going to record the backup data by the storage device; generating a backup key on the basis of the unique information and the received unique key by the storage device; copying the data within the storage device as backup data; encrypting the backup data with the backup key; and transmitting the encrypted backup data to the terminal device.

In a preferable example, when original data that has been recorded in a mobile storage device is backed up, a backup key is generated from a master key that is held by the terminal device that is to back up the data and backup unique information that is held by the mobile storage device, and the backup data is encrypted within the mobile storage device with the backup key. Then, the encrypted backup data is transmitted to a storage area within the terminal device, for example, an HDD.

When the backup data is restored, the mobile storage device is connected to the terminal device, the backup unique information within the mobile storage device is transmitted to the terminal device. The terminal device generates a backup key on the basis of the obtained backup unique information and the master key held by the terminal device, and decrypts the encrypted backup data. The terminal device destroys a circuit of the mobile storage device that records the original data, or detects the backup unique information and makes the original data in the mobile storage device in valid before the terminal device outputs the backup data to a second storage device.

According to the present invention, it is possible to securely backs up data that has been recorded in the mobile storage device.

### BRIEF DESCRIPTION OF THE DRAWINGS

These and other objects and advantages of this invention will become more fully apparent from the following detailed description taken with the accompanying drawings in which:

FIG. 1 is a block diagram showing the configuration of a storage system according to an embodiment;

FIG. 2 is a diagram showing the function of a storage system according to the embodiment;

FIG. 3 is a diagram for explaining a backup method according to the embodiment;

FIG. 4 is a diagram showing a list of the definitions of keys and data according to the embodiment;

FIG. 5 is a diagram for explaining a method of decrypting encrypted backup data in order to execute restoration according to the embodiment; and

FIG. 6 is a diagram for explaining a method of transmitting decrypted data to another storage medium according to the embodiment.

### DETAILED DESCRIPTION OF THE PREFERRED EMBODIMENT

Hereinafter, a description will be given of an embodiment of the present invention with reference to the accompanying drawings.

### System Configuration

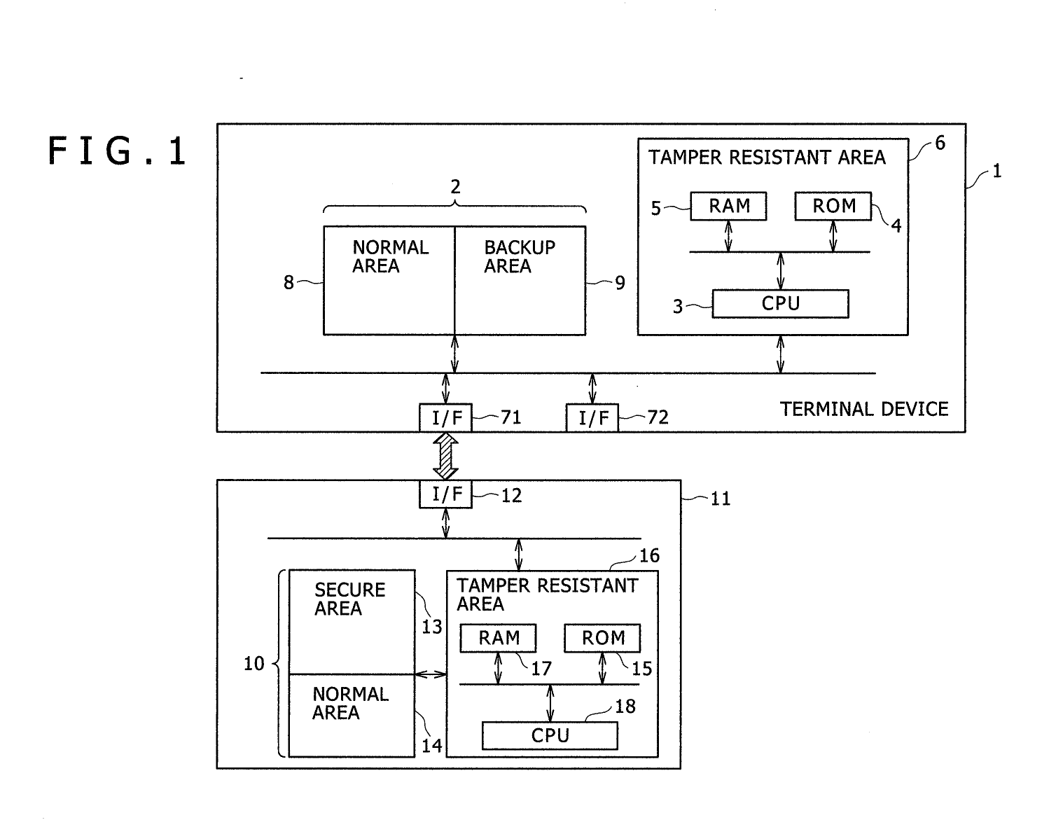

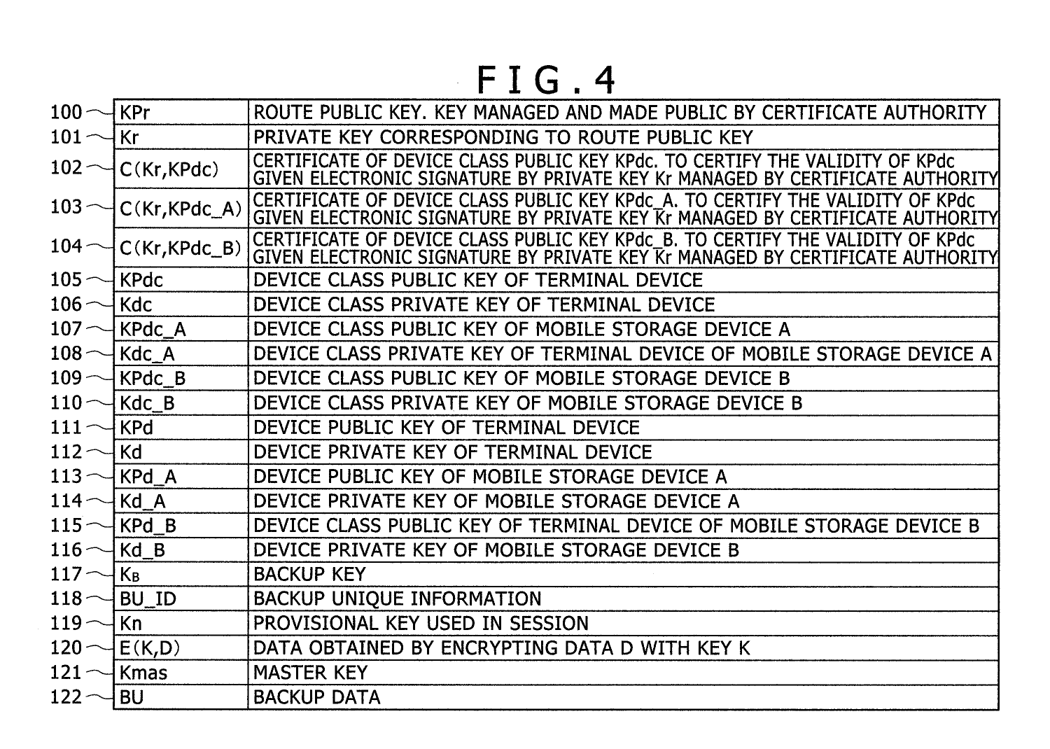

FIG. 1 is a diagram showing the configuration of a storage system according to an embodiment, and FIG. 4 is a diagram showing a list of the definitions of keys and data.

A terminal device 1 includes a built-in HDD 2, a CPU 3, a RAM 5, a ROM 4, and an external interface 7. The built-in HDD 2 is made up of a normal area 8 having no access limit, and a backup area 9 that can be accessed by only a specific command which cannot be directly operated by a user.

The CPU 3 executes program that has been recorded in the ROM 4. In the ROM 4 are recorded a certificate 102 of the terminal device 1, a master key 121 unique to the terminal device 1, a device class public key 105, a device class private key 106, a device public key 111, a device private key 112, and a program (refer to FIG. 4). The RAM 5 is used as a memory when the CPU 3 executes the program. The CPU 3, the RAM 5, and the ROM 4 are installed in a tamper resistant area 6. The tamper resistant area 6 is an area which cannot be illegally accessed from the external, and whose internal process is not read from the external.

The tamper resistant area 6 is configured in such a manner that, for example, the upper portion of a circuit is covered with a plastic resin, and a signal is not read from the external through an interface between the interior of the tamper resistant area and the external. Interfaces 71 and 72 are external interfaces which are connectable to an external storage medium.

A mobile storage device 11 includes a magnetic disc 10, a CPU 18, a RAM 17, a ROM 15, and an interface 12. The magnetic disc 10 is made up of a normal area 14 having no access limit, and a secure area 13 that can be accessed by only a specific command which cannot be directly operated by a user. The CPU 18 executes program that has been recorded in the ROM 15. In the ROM 15 are recorded a certificate 103 of the mobile storage device 11, unique backup information 118 unique to the storage device, a device class public key 107, a device class private key 108, a device public key 113, a device private key 114, and a program (refer to FIG. 4). Those information pieces may be recorded in the secure area 13.

The RAM 17 is used as a memory when the CPU 18 executes the program. The CPU 18, the RAM 17, and the ROM 15 are installed in a tamper resistant area 16. The tamper resistant area 16 is an area which cannot be illegally accessed from the external. The tamper resistant area 16 is configured in such a manner that, for example, a circuit is covered with a plastic resin, and a signal is not read. The interface 12 is, for example, an HDD interface such as ATA.

In this embodiment, “secure” means that original data cannot be used when the backup data is restored, that is, a copy is not increased in number even if the backup is executed.

### Procedure of Backup

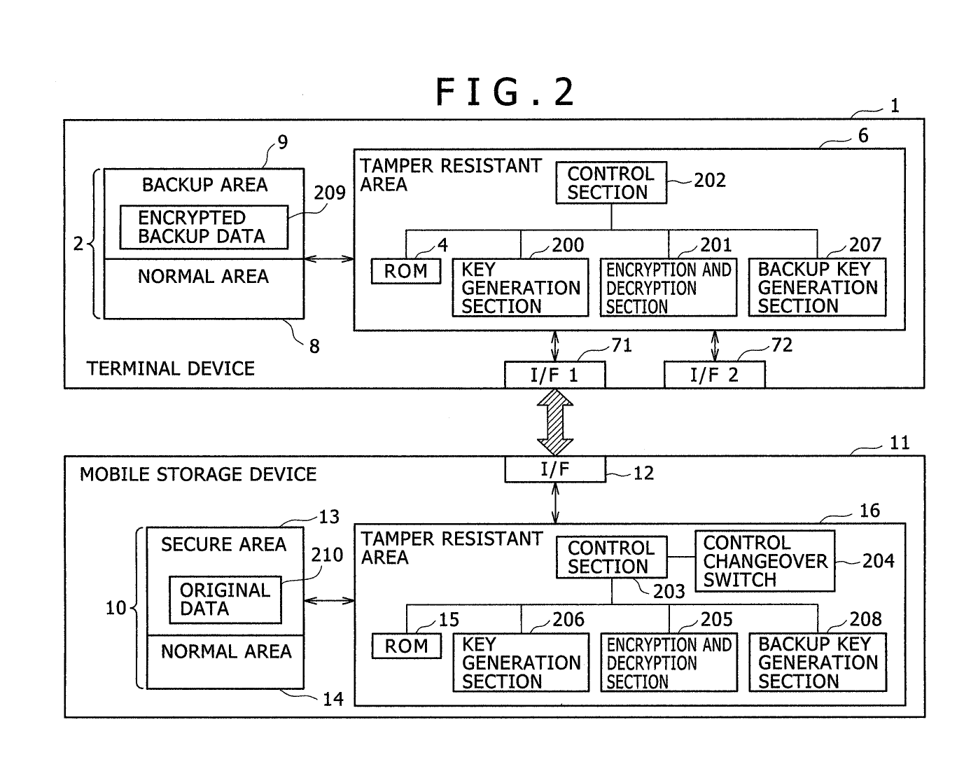

FIG. 2 is a diagram showing the function of the storage system shown in FIG. 1. Reference numerals 200 and 206 denote key generation sections that generate provisional keys necessary for communication, 201 and 205 denote encryption and decryption sections that execute the encryption and decryption of data, and 207 and 208 denote backup key generation sections that generate the backup keys. Reference numeral 204 is a control changeover switch which is a switch with a nonvolatile register. A control section 203 operates or does not operate according to a value of the switch. The control section 203 controls the diverse functions within the tamper resistant area 16. A control section 202 controls the diverse functions within the tamper resistant area 6.

In this embodiment, a system in which encrypted contents and a contents key for decrypting the encrypted contents are distributed, independently, is assumed. Since the contents cannot be used so far as the contents are decrypted, the copy or backup of the contents can be freely performed. On the other hand, the copy or backup of the contents key is limited in order to prevent the unfair use of the contents.

Referring to FIG. 2, a description will be given of a method of backing up the contents key that has been recorded in the secure area 13 of the mobile storage device 11. The start of the backup is instructed by depressing a backup button of the terminal device 1 or a remote controller not shown which is attached to the terminal device 1 by the user. Alternatively, the terminal device 1 can automatically start when the terminal device 1 is connected to the mobile storage device 11. The terminal device 1 and the mobile storage device 11 can be connected to each other through the external interface 71 and the external interface 12.

Upon starting the backup, the mobile storage device 11 obtains a master key Kmas (121) that holds the terminal device 1 that is to back up data. The mobile recording device 11 instructs the backup key generation section 208 to generate a backup key KB (117) by use of a backup unique information BU_ID (118) which are recorded in the ROM 15 and the master key Kmas (121) is not recorded in ROM 15. The backup key KB (117) is generated, for example, by XORing the backup unique information BU_ID (118) and the master key Kmas (121). The backup key KB (117) may be generated through another method when the backup key KB (117) can be generated from the backup unique information BU_ID (118) and the master key Kmas (121).

The mobile storage device 11 encrypts the copy of the original data that has been read from the secure area 13 through the encryption and decryption section 205. After the encryption, the master key Kmas (121) of the terminal device is deleted from the mobile storage device 11. Thereafter, the mobile storage device 11 transmits the encrypted backup data to the terminal device 1. The terminal device 1 records the received encrypted backup data in the backup area 9 of the terminal device 1.

### Protocol of Transmitting Backup Data to Terminal Device 1

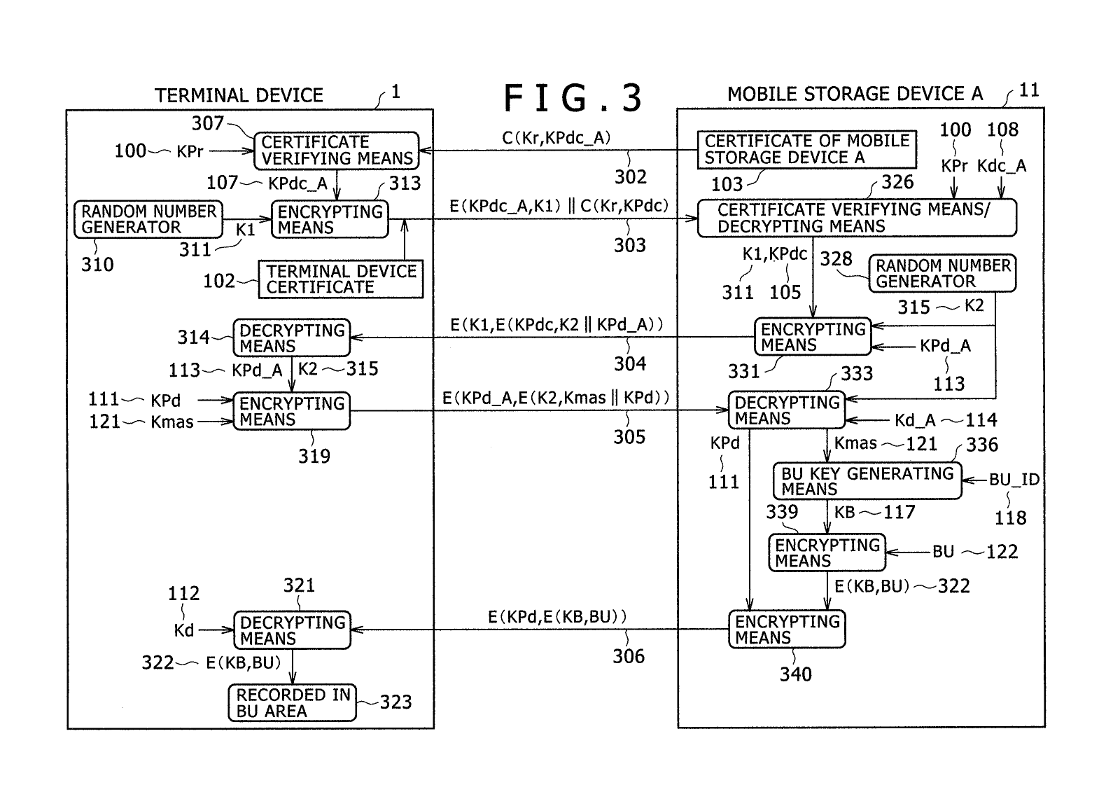

FIG. 3 shows a protocol of generating a backup of data within the mobile storage device 11, and recording the encrypted backup data obtained by encrypting the data in the backup area 9 of the terminal device 1. A description will be given of a protocol of transmitting the backup data of the mobile storage device 11 to the terminal device 1 with reference to FIG. 3.

The mobile storage device 11 first transmits the certificate 103 indicative of the validity of the device class public key of the mobile storage device 11 to the terminal device 1 (302). The certificate 103 is based on, for example, X.509 recommended by ITU (International Telecommunication Union). The terminal device 1 verifies the received certificate 103 (307). Then, the terminal device 1 encrypts the provisional key K1 (311) that has been generated by the random number generator 310 with a device class public key KPdc_A (107) of the mobile storage device 11 which has been obtained by the verification of the certificate 103 (313). Then, the terminal device 1 transmits data obtained by combining the encrypted data with the device class public key certificate 102 of the terminal device 1 to the mobile storage device 11 (303).

The mobile storage device 11 performs the verification of the certificate and the decryption of the encrypted data (326), and obtains the provisional key K1 (311) and the device class public key KPdc (105) of the terminal device. The mobile storage device 11 doubly encrypts the provisional key K2 (315) that has been generated by the random number generator 328 and the device public key KPd_A (113) of the mobile storage device 11 with the provisional key K1 (331) and the device class public key KPdc (105) of the terminal device 1 (331). Then, the mobile storage device 11 transmits the encrypted data to the terminal device 1 (304).

The terminal device 1 decrypts the received encrypted data (314), and obtains the device public key KPd_A (113) and the provisional key K2 (315) of the mobile storage device 11. The terminal device 1 encrypts the device public key KPd (111) and the master key Kmas (121) of the terminal device 1 by use of the obtained device public key KPd_A (113) and provisional key K2 (315) of the mobile storage device 11 (319), and transmits the encrypted data to the mobile storage device 11 (305).

The mobile storage device 11 decrypts the received encrypted data (333), and obtains the device public key KPd (111) and the master key Kmas (121). Then, the mobile storage device 11 XORs the backup unique information BU_ID (118) and the master key Kmas (121) that has been received before to generate the backup key KB (117). Thereafter, the mobile storage device 11 encrypts the data of the original data to be backed up with the backup key KB (117) (339). The mobile storage device 11 again encrypts the encrypted backup data 322 with the device public key KPd (111) of the terminal device 1 (340), and transmits the encrypted data to the terminal device 1 (306).

The terminal device 1 decrypts the encrypted backup data 322 with the device private key Kd (112) of the terminal device 1 (321), and records the decrypted data in the backup area 9 (323). The backup data 122 is recorded in a state where the backup data 122 is encrypted with the backup key KB (117).

### Procedure of Restoration

Subsequently, a description will be given of a method of securely restoring the data that has been recorded in the terminal device 1 with reference to the storage system shown in FIG. 2.

The external interface 12 of the mobile storage device 11 is connected to the external interface 71 of the terminal device 1.

The mobile storage device 11 first transmits the backup unique information BU_ID (118) of the mobile storage device 11 to the terminal device 1 that is to backup the data. The terminal device 1 generates the backup key KB (117) on the basis of the master key Kmas (121) that has been recorded in the ROM (4) and the received backup unique information BU_ID (118) by the backup key generation section (207). The manufacturing method is identical with the method of generating the backup.

The terminal device 1 reads the encrypted backup data 209 that has been recorded in the backup area 9 of the terminal device 1, and decrypts the read data by use of the generated backup key KB (117) by means of the encryption and decryption section 201. After verifying the decryption of data, the terminal device 1 issues an instruction for changing over the switch of the control changeover switch 204 to the mobile storage device 11 in order to prevent the illegal restoration so that the control section of the mobile storage device 11 cannot operate. The control changeover switch 204 is “enable” in an initial value at the time of factory shipment, and becomes “disable” upon receiving a switch changeover command. When the control changeover switch 204 becomes “disable” once, the user is incapable of returning the changeover switch 204 to the “enable” state.

The terminal device 1 disables the control function of the mobile storage device 11 that records the original data 210 so as to make the original data or the data necessary for the restoration unreadable. Thereafter, the terminal device 1 transmits the decrypted backup data to another mobile storage device not shown which is connected to the external interface 72.

When the circuit of the mobile storage device 11 that records the original data 210 is destroyed, the user executes a restoring process only when the mobile storage device 11 that has records the original data 210 is not really available, to thereby enable the illegal restoration to be prevented. Also, instead of the destruction of the circuit, there are proposed a method of deleting the backup unique information BU_ID (118) of the mobile storage device 11 so as to prevent the backup from being taken again, and a method of erasing information necessary to read data from the storage medium.

### Protocol of Decryption of Encrypted Backup Data at the Time of Restoration

The restoration is performed at two stages. At a first stage, the encrypted backup data that has been recorded in the terminal device 1 is decrypted, and at a second stage, the backup data is transmitted to another storage device.

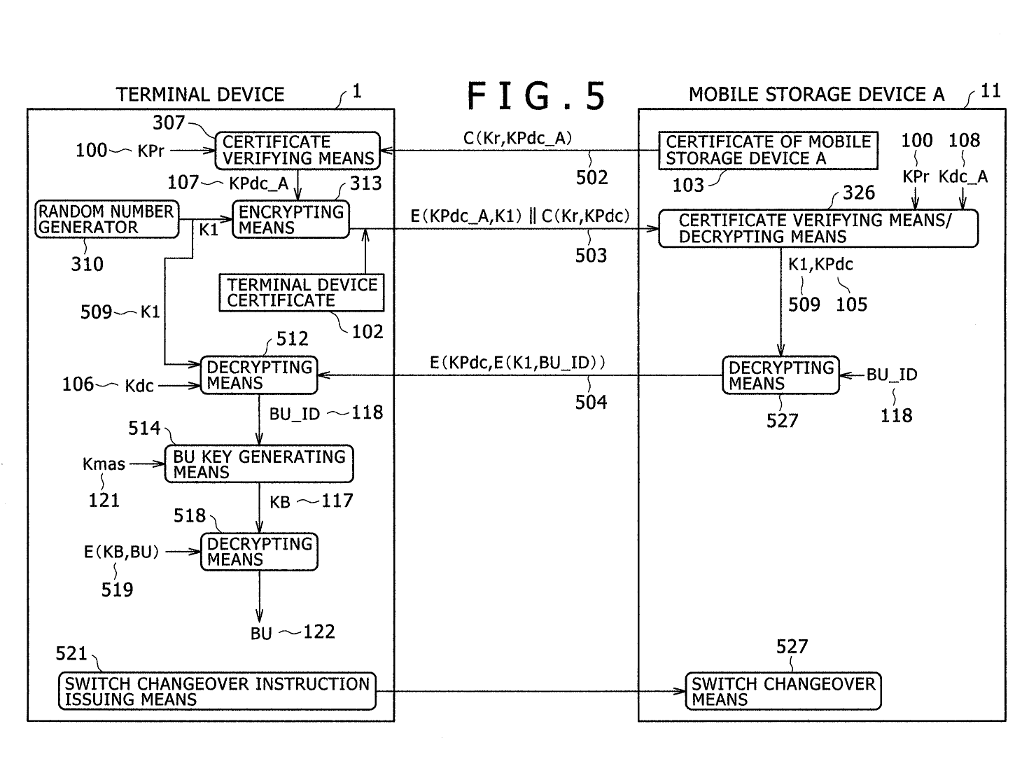

FIG. 5 shows a protocol of decrypting the encrypted backup data that has been recorded in the terminal device 1. A description will be given of a protocol of decrypting the encrypted backup data within the terminal device 1 with reference to FIG. 5.

The mobile storage device 11 first transmits the device class public key certificate (103) of the mobile storage device 11 to the terminal device 1 (502). The terminal device 1 verifies the received certificate (307). Then, the terminal device 1 encrypts the provisional key K1 (509) that has been generated by the random number generator (310) with the device class public key KPdc_A (107) of the mobile storage device 11 which has been obtained by the verification of the certificate (313). Then, the terminal device 1 transmits data obtained by combining the encrypted data with the device class public key certificate (102) of the terminal device 1 to the mobile storage device 11 (503).

The mobile storage device 11 performs the verification of the certificate and the decryption of the encrypted data (326), and obtains the provisional key K1 (509) and the device class public key KPdc (105) of the terminal device 1. The mobile storage device 11 doubly encrypts the backup unique information BU_ID (118) with the provisional key K1 (509) and the device class public key KPdc (105) of the terminal device 1 (527). Then, the mobile storage device 11 transmits the encrypted data to the terminal device 1 (504).

The terminal device 1 decrypts the received encrypted data (512), and obtains the backup unique information BU_ID (118). The terminal device 1 XORs the obtained backup unique information BU_ID (118) and the master key Kmas (121) to generate the backup key KB (117) (514). Then, the terminal device 1 decrypts the encrypted backup data 519 by use of the backup key KB (117) (518). After decrypting the encrypted backup data 519, the terminal device 1 outputs an instruction for changing over the control changeover switch 204 to the mobile storage device 11 (521). The mobile storage device 11 that has received the instruction changes over the switch to a state in which the control section 203 cannot function.

### Protocol of Transmission of Backup Data at the Time of Restoration

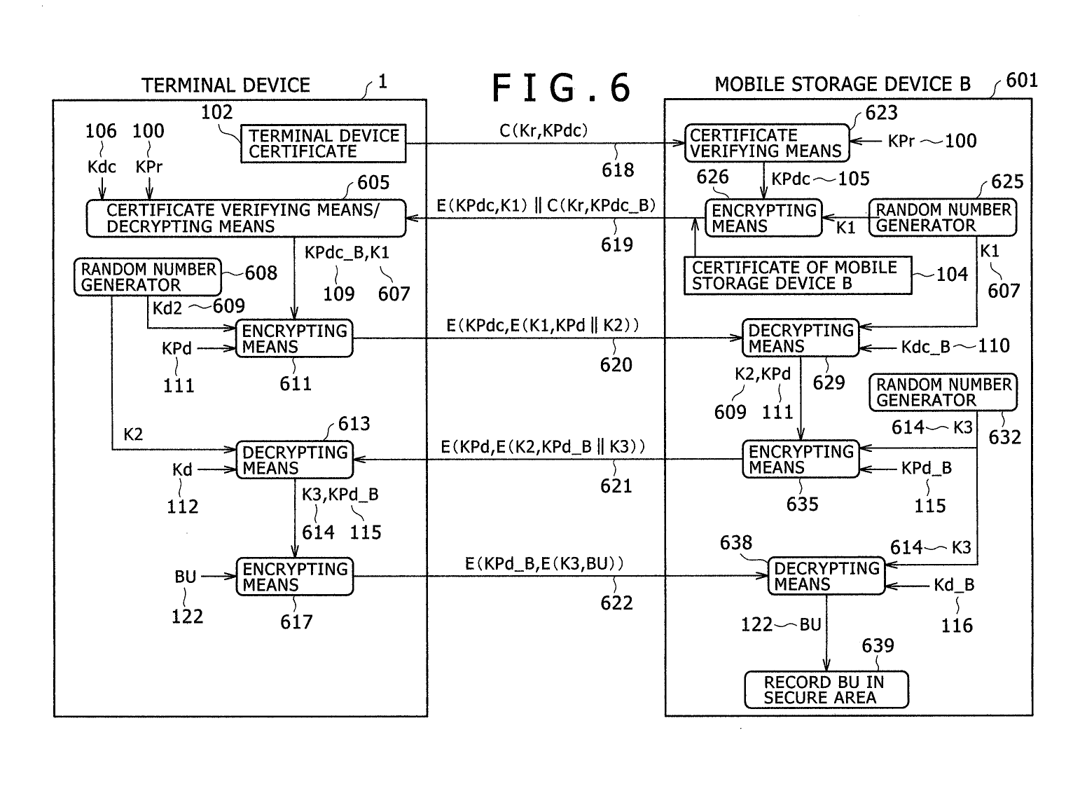

FIG. 6 shows a protocol of transmitting the backup data that has been decrypted by the terminal device 1 to the mobile storage device 601 that is another storage device. A description will be given of the protocol of transmitting the decrypted backup data to another storage device with reference to FIG. 6.

The terminal device 1 first transmits the device class public key certificate 102 of the terminal device 1 to the mobile storage device 601 (618). The mobile storage device 601 verifies the received certificate (623). Then, the mobile storage device 601 encrypts a provisional key K1 (607) that has been generated by a random number generator 625 with the device class public key KPdc (105) of the terminal device 1 which has been obtained by the verification of a certificate (626). Then, the mobile storage device 601 transmits data obtained by combining the encrypted data with the device class public key certificate (104) of the mobile storage device 601 to the terminal device 1 (619).

The terminal device 1 performs the verification of the certificate and the decryption of the encrypted data (605), and obtains the provisional key K1 (607) and the device class public key KPdc_B (109) of the mobile device 601. The terminal device 1 doubly encrypts a provisional key K2 (609) that has been generated by a random number generator 608 and the device public key KPd (111) of the terminal device 1 with the provisional key K1 (607) and the device class public key KPdc_B (109) of the mobile storage device 601 (611). Then, the terminal storage device 1 transmits the encrypted data to the mobile storage device 601 (620).

The mobile storage device 601 decrypts the encrypted data (629), and obtains the provisional key K2 (609) and the device public key KPd (111) of the terminal device. Then, the mobile storage device 601 encrypts a provisional key K3 (614) that has been generated by a random number generator 632 and a device public key KPd_B (115) of the mobile storage device 601 with the provisional key K2 (609) that has been obtained before and the device public key KPd (111) of the terminal device (635), and transmits the encrypted data to the terminal device 1 (621).

The terminal device 1 decrypts the received encrypted data (613) to obtain the provisional key K3 (614) and the device public key KPd_B (115) of the mobile storage device 601. The terminal device 1 encrypts the backup data 122 with the provisional key K3 (614) that has been obtained before and the device public key KPd_B (115) of the mobile storage device 601 (617). Then, the terminal device 1 transmits the encrypted data to the mobile storage device 601 (622). The mobile storage device 601 decrypts the data (638), and obtains the backup data 122. The backup data, that is, the contents key is stored in the secure area of a mobile storage device B.

According to this embodiment, the backup of the original data has been recorded in the plural terminals through the above protocols, thereby enabling the data to be securely restored.

For example, the backup data of the mobile storage device 11 is recorded in an STB1 (set top box) that is in a living room and an STB2 that is in a drawing room in the above-described method. In the case where the user executes the restoration of the mobile storage device 11 by use of the STB1, the control changeover switch 204 of the mobile storage device 11 is disabled before the backup data is output to another storage device from the STM1.

Even if the user again tries to connect to the mobile storage device STB2 for restoration, the control section of the mobile storage device 11 does not function. As a result, the original data and the backup unique information 118 necessary for the restoration of the backup data in STB2 are incapable of obtaining. Since the STB2 is incapable of generating the backup key for decrypting the encrypted backup data without providing the backup unique information, it is impossible to execute the restoration.

Also, the backup unique information 118 of the mobile storage device 11 can be erased instead of disabling the control switch 204.

As described above, according to this embodiment, it is possible that the backup of the contents are located in plural places with the results that even in the case where the terminal device used for the backup is destroyed or fails, it is possible to use the backup provided in another terminal device.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A storage device that connects to an external device so as to communicate with the external device, which has a storage area that records data therein, and a control section that controls the record of data in the storage area, the storage device comprising:
switching means for switching functions of the control section under the control;
means for holding unique information belong to the storage device;
means for receiving a unique key belonging to the external device from the external device;
means for generating a backup key by use of the unique key belonging to the external device which has been obtained from the external device and the unique information belonging to the storage device; and
means for encrypting a copy of digital data that has been recorded in the storage device by use of the backup key.

2. The storage device according to claim 1, wherein the switching means comprises a nonvolatile register having means for changing a value that is stored in the register according to a command from the external device, and disabling the function of the control section according to the value.

3. A storage device that connects to an external device so as to communicate with the external device, the storage device comprising:
means for holding unique information belong to the storage device;
means for receiving a unique key belonging to the external device from the external device;
means for generating a backup key by use of the unique key belonging to the external device which has been obtained from the external device and the unique information belonging to the storage device;
means for encrypting a copy of digital data that has been recorded in the storage device by use of the backup key; and
means for deleting the unique information belonging to the storage device according to a command from the external device.

4. A terminal device that is communicable with an external device, the terminal device comprising:
means for holding unique information belong to the terminal device;
means for outputting the unique key to a storage device;
means for receiving encrypted digital data that has been transmitted from the storage device;
a storage area that records the encrypted digital data that has been transmitted from the storage device;
means for generating a backup key by use of the unique information that has been transmitted from the storage device and the unique key that has been held by the terminal device;
means for decrypting the encrypted digital data that has been transmitted from the storage device by use of the backup key;
means for outputting one of a command for disabling a control function of the storage device or a command for deleting the unique information that is held by the storage device; and
means for transmitting the decrypted digital data to a second storage device.

5. A method of backing up data that has been recorded in a storage device, the method comprising:
holding unique information belonging to the storage device in advance;
receiving a unique key held by a terminal device that records the backup data by the storage device;
generating a backup key on the basis of the unique information and the received unique key by the storage device;
copying the data within the storage device as backup data;
encrypting the backup data with the backup key; and
transmitting the encrypted backup data to the terminal device.

6. The method of backing up data that has been recorded in the storage device according to claim 5, the method comprising:
receiving the backup data that has been encrypted by the storage device, and recording the received backup data in a storage area of the terminal device by the terminal device;
obtaining the unique information from the storage device by the terminal device;
generating the backup key on the basis of the unique information and the unique key that is held by the terminal device;
decrypting the encrypted backup data by use of the backup key;
encrypting the decrypted backup data by use of a provisional key shared by the terminal device and a second storage device; and
transmitting the encrypted backup data to the second storage device after disabling the control function of the storage device.

7. The method of backing up data that has been recorded in the storage device according to claim 5, the method comprising:
receiving the backup data that has been encrypted by the storage device, and recording the received backup data in a storage area of the terminal device by the terminal device;
obtaining the unique information from the storage device by the terminal device;
generating the backup key on the basis of the unique information and the unique key that is held by the terminal device;
decrypting the encrypted backup data by use of the backup key;
encrypting the decrypted backup data by use of a provisional key shared by the terminal device and a second storage device; and
transmitting the encrypted backup data to the second storage device after deleting the unique key that is held by the storage device.
